(19) United States
(12) Patent Application Publication
(10) Pub. No.: US 2010/0183872 A1
(43) Pub. Date: Jul. 22, 2010

(54) Double-coated pressure sensitive adhesive sheet for fixing flexible printed circuit board

(75) Inventors: Takahiro Nonaka, Osaka (JP); Noritsugu Daigaku, Osaka (JP); Masahiro Oura, Osaka (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-shi (JP)

(21) Appl. No.: 12/654,892

(22) Filed: Jan. 7, 2010

(30) Foreign Application Priority Data
Jan. 21, 2009 (JP) 2009-011242

(51) Int. Cl. B32B 9/04; B32B 23/00

(52) U.S. Cl. 428/336

(57) ABSTRACT

Disclosed is a double-coated pressure-sensitive adhesive sheet for fixing a flexible printed circuit board, which includes at least a pressure-sensitive adhesive unit including a plastic base film having a thickness of 13 μm or less, and pressure-sensitive adhesive layers on both sides of the plastic base film. The pressure-sensitive adhesive layers are formed from an acrylic polymer containing, as essential monomer components, a polar-group-containing monomer and an alkyl (meth)acrylate whose alkyl moiety being a linear or branched-chain alkyl group having 2 to 14 carbon atoms. The pressure-sensitive adhesive unit has a thickness of 60 μm or less, the double-coated pressure-sensitive adhesive sheet shows an outgassing of 1 μg/cm² or less when heated at 120° C. for 10 minutes, and shows a split distance (lifting) of 1.5 mm or less.

### BACKGROUND OF THE INVENTION

1. Field of the Invention

The present invention relates to double-coated pressure-sensitive adhesive sheets adopted to fix flexible printed circuit boards.

2. Description of the Related Art

Double-coated pressure-sensitive adhesive sheets (double-sided self-adhesive sheets) are currently generally used for the fixation of a flexible printed circuit board (hereinafter also referred to as “FPC”) typically to a cabinet in the fabrication of hard disk drives (magnetic recording systems; HDDs).

Examples of such double-coated pressure-sensitive adhesive sheets include one whose release liner has improved processability, causes less contamination, and induces less outgassing (see Japanese Patent No. 3901490); and one which has improved thermal stability and processability (see Japanese Unexamined Patent Application Publication (JP-A) No. 2006-89564).

### SUMMARY OF THE INVENTION

However, even these double-coated pressure-sensitive adhesive sheets have been found to suffer from the following problems. Specifically, the double-coated pressure-sensitive adhesive sheets show insufficient processability when designed to have a so-called “base-less” structure using no base or carrier. On the other hand, when designed to have a base-containing structure including a plastic base film and pressure-sensitive adhesive layers arranged thereon so as to improve the processability, and when used for fixing a FPC, the double-coated pressure-sensitive adhesive sheets may suffer typically from “lifting (insufficient adhesion)” of the FPC from a substrate due to heat applied typically in a sealing process after the fixation of FPC, in which such split distance occurs typically at a portion with “bumps” (steps) in interconnections. Additionally, such double-coated pressure-sensitive adhesive sheets may be applied to an adherend bearing a fine pattern, such as a circuit pattern, and thereby having fine bumps (fine steps) on its surface. In this case, the pressure-sensitive adhesive layer may not sufficiently fit and come into a narrow space between the pattern (traces) and may not satisfactorily fit around bumps. This causes a gap between the adherend and the pressure-sensitive adhesive layer. This problem occurs particularly when it is undesirable or difficult to apply a pressure for the fixation of the double-coated pressure-sensitive adhesive sheets. Specifically, there has been obtained no double-coated pressure-sensitive adhesive sheet that satisfies the requirements for satisfactory processability and less outgassing (more suppressing outgassing) and also satisfies requirements for satisfactory fittability around bumps upon affixation and less “lifting” after the affixation.

Accordingly, an object of the present invention is to provide a superior double-coated pressure-sensitive adhesive sheet adopted to fix a flexible printed circuit board, which shows excellent processability, causes less outgassing, satisfactorily fits around bumps, and, in addition, does not cause “lifting” from an adherend during working or processing after affixed to the adherend.

After intensive investigations to achieve the object, the present inventors have found that a double-coated pressure-sensitive adhesive sheet that has superior processability, suppresses outgassing (causes less outgassing), satisfactorily fits around bumps, and prevents “lifting” after affixation can be obtained by configuring a pressure-sensitive adhesive sheet having a specific thickness from a plastic base film with a specific thickness, and pressure-sensitive adhesive layers having a specific formulation or composition. The present invention has been made based on these findings.

Specifically, the present invention provides, in an aspect, a double-coated pressure-sensitive adhesive sheet for fixing a flexible printed circuit board, the sheet includes at least a pressure-sensitive adhesive unit including a plastic base film having a thickness of 13 μm or less; a first pressure-sensitive adhesive layer present on or above one surface of the plastic base film; and a second pressure-sensitive adhesive layer present on or above the other surface of the plastic base film. In the sheet, each of the first and second pressure-sensitive adhesive layers includes an acrylic polymer containing one or more polar-group-containing monomers and one or more alkyl (meth)acrylates whose alkyl moiety being a linear or branched-chain alkyl group having 2 to 14 carbon atoms as essential monomer components, and the pressure-sensitive adhesive unit has a thickness of 60 μm or less, and the double-coated pressure-sensitive adhesive sheet shows an outgassing of 1 microgram per square centimeter (μg/cm²) or less when heated at 120° C. for 10 minutes, and shows a split distance of 1.5 mm or less. The split distance herein is determined in the following manner: A test specimen is prepared by affixing one adhesive face of the double-coated pressure-sensitive adhesive sheet to an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-coated pressure-sensitive adhesive sheet is affixed to an adherend through compression bonding using a roll laminator, where the adherend is a sheet prepared by affixing a polyimide film to a polypropylene sheet 2 mm thick, and the other adhesive face is affixed to the polyimide film of the adherend; the resulting article is left stand at 23° C. for 24 hours, thereafter heated at 70° C. for 2 hours, and the height or distance (mm) of an end of the test specimen lifted or raised from the adherend surface is measured and defined as the “split distance” (mm).

The double-coated pressure-sensitive adhesive sheet for fixing a flexible printed circuit board may further include a non-silicone release liner or liners present on or above both surfaces of the pressure-sensitive adhesive unit.

Each of the first and second pressure-sensitive adhesive layers preferably has a gel fraction of from 10% to 60%.

Each of the first and second pressure-sensitive adhesive layers may be formed from an acrylic pressure-sensitive adhesive including one or more acrylic polymers and one or more crosslinking agents and containing substantially no tackifier resin.

The acrylic pressure-sensitive adhesive may contain 0.15 to 1 part by weight of one or more isocyanate crosslinking agents and 0 to 0.05 part by weight of one or more epoxy crosslinking agents per 100 parts by weight of the acrylic polymers.

The double-coated pressure-sensitive adhesive sheet for fixing a flexible printed circuit board may include a polyolefinic release liner or liners as the non-silicone release liner or liners on or above both surfaces of the pressure-sensitive adhesive unit.

The double-coated pressure-sensitive adhesive sheet for fixing a flexible printed circuit board, according to an embodiment of the present invention, has the above configuration, thereby shows satisfactory processability, causes less outgassing, and satisfactorily fits around bumps. In addition, it is resistant to “lifting” from an adherend even after affixed to the adhered and subjected to a heating process. These advantages improve the productivity and quality of a product manufactured while fixing a flexible printed circuit board typically to a cabinet through the double-coated pressure-sensitive adhesive sheet.

### BRIEF DESCRIPTION OF THE DRAWINGS

These and other objects, features, and advantages of the present invention will be more fully understood from the following description of preferred embodiments with reference to the attached drawings, in which:

FIG. 1 is a schematic cross-sectional view of a double-coated pressure-sensitive adhesive sheet according to an embodiment of the present invention;

FIG. 2 is an explanatory drawing (schematic cross-sectional view) showing a multilayer structure of a FPC used for testing for fittability around bumps; and

FIG. 3 is an explanatory drawing (plan view seen from the base film layer side) showing how the FPC and a double-coated pressure-sensitive adhesive sheet (test sample) are affixed in the testing for fittability around bumps.

### DESCRIPTION OF THE PREFERRED EMBODIMENTS

The present invention will be illustrated further with reference to various embodiments and, where necessary, to the attached drawings. All numbers are herein assumed to be modified by the term “about.”

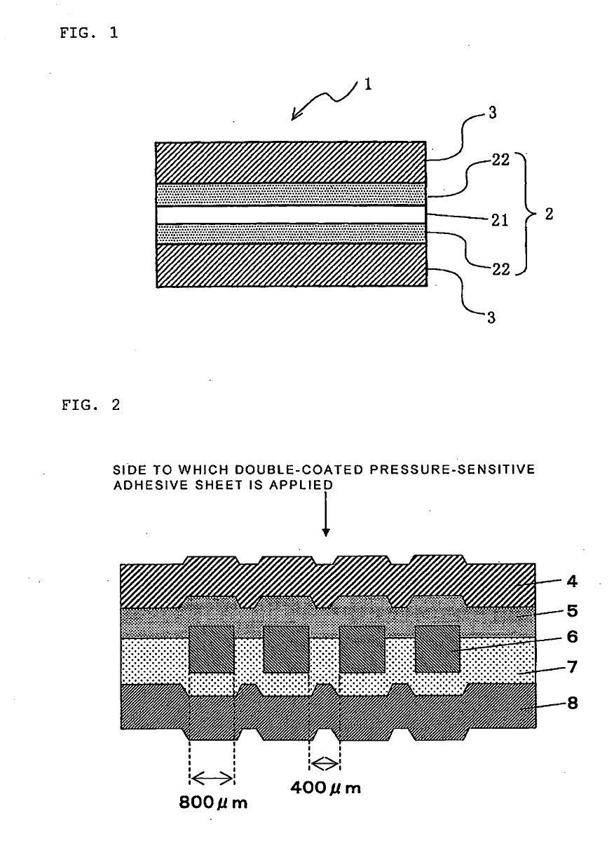

A double-coated pressure-sensitive adhesive sheet according to an embodiment of the present invention includes at least a pressure-sensitive adhesive unit. The double-coated pressure-sensitive adhesive sheet preferably further includes a release liner or liners on or above a surface or surfaces of the pressure-sensitive adhesive unit according to necessity. FIG. 1 is a schematic cross-sectional view of a double-coated pressure-sensitive adhesive sheet for fixing a flexible printed circuit board (FPC), according to an embodiment of the present invention (hereinafter also simply referred to as a “double-coated pressure-sensitive adhesive sheet according to the present invention”). The double-coated pressure-sensitive adhesive sheet 1 includes a pressure-sensitive adhesive unit (portion other than release liners) 2, and the pressure-sensitive adhesive unit 2 includes a plastic base film 21, and pressure-sensitive adhesive layers 22 present on or above both sides of the plastic base film 21. The double-coated pressure-sensitive adhesive sheet 1 preferably further includes a release liner or liners 3 on or above both sides of the pressure-sensitive adhesive unit 2. As used herein the term “double-coated pressure-sensitive adhesive sheet” also means and includes one in the form of a tape, i.e., a “double-coated pressure-sensitive adhesive tape”. As used herein the term “pressure-sensitive adhesive unit” refers to a portion of the double-coated pressure-sensitive adhesive sheet which portion is affixed to adherends upon use, i.e., it generally refers to a portion of the double-coated pressure-sensitive adhesive sheet other than release liners.

Pressure-Sensitive Adhesive Unit

A pressure-sensitive adhesive unit for use in the double-coated pressure-sensitive adhesive sheet according to the present invention has a multilayer structure including a plastic base film, and present on or above both sides thereof, pressure-sensitive adhesive layers, as described above. Specifically, the pressure-sensitive adhesive unit is a double-coated pressure-sensitive adhesive unit which has adhesive faces (pressure-sensitive adhesive layer surfaces) as both surfaces. In addition to the plastic base film and pressure-sensitive adhesive layers, the pressure-sensitive adhesive unit for use herein may further include one or more other layers, such as intermediate layers and undercoating layers, within ranges not adversely affecting the advantages of the present invention. The plastic base film may be laminated with each of the pressure-sensitive adhesive layers directly or indirectly with the interposition of one or more other layers such as intermediate layers.

The thickness of the pressure-sensitive adhesive unit is 60 μm or less, preferably from 10 to 60 μm, more preferably from 25 to 60 μm, and furthermore preferably from 40 to 60 μm. A pressure-sensitive adhesive unit having a thickness of more than 60 μm may be disadvantageous in the reduction of thickness and size of a product, such as a hard disk drive, in which a FPC is fixed through the double-coated pressure-sensitive adhesive sheet. In contrast, a pressure-sensitive adhesive unit having an excessively small thickness of less than 10 μm may adversely affect the processability, handleability, and/or adhesiveness of the double-coated pressure-sensitive adhesive sheet. As used herein the term “thickness of the pressure-sensitive adhesive unit” refers to a thickness from one adhesive face (surface of one of the pressure-sensitive adhesive layers) of the pressure-sensitive adhesive unit to the other adhesive face.

Plastic Base Film

A plastic base film for use in the pressure-sensitive adhesive unit of the double-coated pressure-sensitive adhesive sheet is a support for the pressure-sensitive adhesive layers and plays a role of improving the processability and handleability (handling properties) of the double-coated pressure-sensitive adhesive sheet. The plastic film can be one generally used as a support of a pressure-sensitive adhesive sheet. Exemplary plastic films include resin films containing resins such as polyester resins, olefinic resins, poly(vinyl chloride) resins, acrylic resins, vinyl acetate resins, amide resins, polyimide resins, poly(ether ether ketone)s, and poly(phenylene sulfide)s. Among them, preferred are polyester films and polyolefin films, of which poly(ethylene terephthalate) (PET) films are more preferred from the viewpoints of cost and rigidity. The plastic base film for use herein may have a single-layer structure or multilayer structure.

The plastic base film may have been subjected to a common surface treatment to increase adhesion to the pressure-sensitive adhesive layers. Exemplary surface treatments include chromate treatment, exposure to ozone, exposure to a flame, exposure to a high-voltage electric shock, ionizing radiation treatment, and other chemical or physical oxidizing treatments. In addition or alternatively, the plastic base film may have been subjected to another treatment such as coating with a primer.

The thickness of the plastic base film is 13 μm or less (for example, from 2 to 13 μm), and preferably from 4 to 12 μm. By configuring the base film to have a thickness of 13 μm or less, the double-coated pressure-sensitive adhesive sheet can have improved “fittability around bumps”. The term “fittability around bumps” (also referred to as “bump-absorptivity”) refers to such a property that, when affixed to an adherend, the pressure-sensitive adhesive sheet easily fits or conforms to bumps (roughness) of the adherend. When such a double-coated pressure-sensitive adhesive sheet having satisfactory fittability around bumps is affixed typically to an adherend having a fine pattern (fine traces), such as a FPC, the pressure-sensitive adhesive layers can fit and come into fine spaces between the traces, and the sheet more satisfactorily adheres to the adherend, even when the sheet is affixed to the adhered under a weak (small) pressing force. The advantageous effects are obtained because the thicknesses of the pressure-sensitive adhesive layers are set to be relatively larger than that of the plastic base film. In contrast, if a double-coated pressure-sensitive adhesive sheet including a base film having a thickness of more than 13 μm is affixed under a weak pressing force to an adherend bearing fine traces, it may often suffer from a gap between the adherend and the pressure-sensitive adhesive layer. In addition, such a plastic base film having an excessively large thickness of more than 13 μm may have an excessively high rigidity to often cause “lifting” after affixation and may be disadvantageous in the reduction of size and thickness of a product to be manufactured while fixing a FPC through the double-coated pressure-sensitive adhesive sheet. In contrast, if the plastic base film has an excessively small thickness, it may be difficult to apply pressure-sensitive adhesive layers thereto through direct application and/or it may be relatively difficult to handle the double-coated pressure-sensitive adhesive sheet.

Pressure-Sensitive Adhesive Layers

Pressure-sensitive adhesive layers in the pressure-sensitive adhesive unit of the double-coated pressure-sensitive adhesive sheet are each formed from an acrylic polymer or polymers. More specifically, the pressure-sensitive adhesive layers are each formed from an acrylic pressure-sensitive adhesive containing one or more acrylic polymers as a principal component. The acrylic pressure-sensitive adhesive includes the acrylic polymers and, for example, one or more crosslinking agents. The acrylic pressure-sensitive adhesives may further contain one or more additives according to necessity. The content of the principal component acrylic polymer in the acrylic pressure-sensitive adhesive is preferably 90 percent by weight or more, and more preferably 95 percent by weight or more, of the total weight of solids contents of the acrylic pressure-sensitive adhesive.

The acrylic polymers each play a role of developing adhesiveness (tacky adhesiveness) as a base polymer of the pressure-sensitive adhesive layers. The acrylic polymers may be a copolymer containing, as essential monomer components, one or more alkyl (meth)acrylates whose alkyl moiety being a linear or branched-chain alkyl group having 2 to 14 carbon atoms (hereinafter also referred to as “(meth)acrylic C₂-C₁₄ alkyl ester(s)”) and one or more monomers containing a polar group (hereinafter also referred to as “polar-group-containing monomer(s)”). The acrylic polymers may further include, as monomer components, one or more additional monomer components in addition to the (meth)acrylic C₂-C₁₄ alkyl esters and polar-group-containing monomers. Each of the (meth)acrylic C₂-C₁₄ alkyl esters, the polar-group-containing monomers, and the additional monomer components may be used alone or in combination, respectively.

As used herein the term “(meth)acrylic” refers to “acrylic” and/or “methacrylic”, and the same is true for other descriptions.

The (meth)acrylic C₂-C₁₄ alkyl esters are alkyl (meth)acrylates whose alkyl moiety being a linear or branched-chain alkyl group having 2 to 14 carbon atoms, and examples thereof include ethyl (meth)acrylates, propyl (meth)acrylates, isopropyl (meth)acrylates, butyl (meth)acrylates (n-butyl (meth)acrylates), isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth)acrylates, 2-ethylhexyl (meth)acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth)acrylates, tridecyl (meth)acrylates, and tetradecyl (meth)acrylates. Among them, preferred are alkyl (meth)acrylates whose alkyl moiety being a linear or branched-chain alkyl group having 2 to 10 carbon atoms, of which 2-ethylhexyl acrylate and butyl acrylate are more preferred.

The content of the (meth)acrylic C₂-C₁₄ alkyl esters may be from 50 to 99 percent by weight, preferably from 80 to 97 percent by weight, and furthermore preferably from 90 to 95 percent by weight, based on the total amount (100 percent by weight) of monomer components configuring the acrylic polymer. An acrylic polymer, if having a content of (meth)acrylic C₂-C₁₄ alkyl esters of less than 50 percent by weight, may less tend to exhibit properties as an acrylic polymer, such as tacky adhesiveness. In contrast, an acrylic polymer, if having a content of (meth)acrylic C₂-C₁₄ alkyl esters of more than 99 percent by weight, may exhibit insufficient adhesiveness due to excessively small content of polar-group-containing monomers.

The polar-group-containing monomers are monomers having at least one polar group per one molecule, of which ethylenically unsaturated monomers are preferred. Exemplary polar-group-containing monomers include carboxyl-containing monomers such as (meth)acrylic acids, itaconic acid, maleic acid, fumaric acid, crotonic acid, and isocrotonic acid, and anhydrides of them, such as maleic anhydride; hydroxyl-containing monomers including hydroxyalkyl (meth)acrylates such as 2-hydroxyethyl (meth)acrylates, 3-hydroxypropyl (meth)acrylates, 4-hydroxybutyl (meth)acrylates, and 6-hydroxyhexyl (meth)acrylates, as well as vinyl alcohol and allyl alcohol; amido-containing monomers such as (meth)acrylamides, N,N-dimethyl(meth)acrylamides, N-methylol(meth)acrylamides, N-methoxymethyl(meth)acrylamides, N-butoxymethyl(meth)acrylamides, and N-hydroxyethylacrylamide; amino-containing monomers such as aminoethyl (meth)acrylates, dimethylaminoethyl (meth)acrylates, and t-butylaminoethyl (meth)acrylates; glycidyl-containing monomers such as glycidyl (meth)acrylates and methylglycidyl (meth)acrylates; cyano-containing monomers such as acrylonitrile and methacrylonitrile; heterocycle-containing vinyl monomers such as N-vinyl-2-pyrrolidone, (meth)acryloylmorpholine, N-vinylpyridine, N-vinylpiperidone, N-vinylpyrimidine, N-vinylpiperazine, N-vinylpyrrole, N-vinylimidazole, and N-vinyloxazole; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Each of different polar-group-containing monomers can be used alone or in combination. Of these polar-group-containing monomers, preferred are carboxyl-containing monomers, acid anhydrides of them, and hydroxyl-containing monomers, of which acrylic acid (AA) and 4-hydroxybutyl acrylate (4HBA) are more preferred.

The content of the polar-group-containing monomers is preferably from 1 to 30 percent by weight, and more preferably from 3 to 20 percent by weight, based on the total amount (100 percent by weight) of monomer components configuring the acrylic polymer. An acrylic polymer, if having a content of polar-group-containing monomers of more than 30 percent by weight, may cause an excessively high cohesive strength of the acrylic pressure-sensitive adhesive to cause insufficient tacky adhesiveness of the pressure-sensitive adhesive layers. An acrylic polymer, if having a content of polar-group-containing monomers of less than 1 percent by weight, may cause an insufficient cohesive strength of the acrylic pressure-sensitive adhesive, and this may cause the double-coated pressure-sensitive adhesive sheet to show an insufficient shear bond strength and/or insufficient adhesiveness. Above all, the content of carboxyl-containing monomers or anhydrides of them (especially the content of acrylic acid) is preferably from 1 to 20 percent by weight, and more preferably from 3 to 10 percent by weight, based on the total amount (100 percent by weight) of monomer components configuring the acrylic polymer. This range is preferred from the viewpoint of exhibiting satisfactory adhesiveness. The content of hydroxyl-containing monomers (especially the content of 4HBA) is preferably from 0.01 to 10 percent by weight, and more preferably from 0.03 to 5 percent by weight, based on the total amount (100 percent by weight) of monomer components configuring the acrylic polymer. This range is preferred from the viewpoint of crosslinking properties.

The additional monomer components are monomers other than the (meth)acrylic C₂-C₁₄ alkyl esters and polar-group-containing monomers, of which ethylenically unsaturated monomers are preferred. Exemplary additional monomer components include methyl (meth)acrylates; alkyl (meth)acrylates whose alkyl moiety being a linear or branched-chain alkyl group having 15 or more carbon atoms, such as pentadecyl (meth)acrylates, hexadecyl (meth)acrylates, heptadecyl (meth)acrylates, octadecyl (meth)acrylates, nonadecyl (meth)acrylates, and eicosyl (meth)acrylates; (meth)acrylates having an alicyclic hydrocarbon group, such as cyclopentyl (meth)acrylates, cyclohexyl (meth)acrylates, and isobornyl (meth)acrylates; aryl (meth)acrylates such as phenyl (meth)acrylates; vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride. Exemplary additional monomer components further include multifunctional monomers such as hexanediol di(meth)acrylates, butanediol di(meth)acrylates, (poly)ethylene glycol di(meth)acrylates, (poly)propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethylolpropane tri(meth)acrylates, tetramethylolmethane tri(meth)acrylates, allyl (meth)acrylates, vinyl (meth)acrylates, divinylbenzene, epoxy acrylates, polyester acrylates, and urethane acrylates. Each of different additional monomer components can be used alone or in combination.

Such acrylic polymers can be prepared by polymerizing (copolymerizing) the monomer components according to a known or common polymerization technique. Exemplary polymerization techniques of acrylic polymers include solution polymerization, emulsion polymerization, mass polymerization (bulk polymerization), and polymerization through ultraviolet irradiation. Among them, solution polymerization is preferred from the viewpoints of cost and mass productivity. Upon polymerization of acrylic polymers, suitable components, such as polymerization initiators, chain-transfer agents, emulsifiers, and solvents, can be chosen from among known or common ones according to the polymerization technique.

Azo initiators are preferred as polymerization initiators for use in polymerization of the acrylic polymer through solution polymerization, of which more preferred are the azo initiators disclosed in Japanese Unexamined Patent Application Publication (JP-A) No. 2002-69411. Such azo initiators are preferred because their decomposed products are unlikely to remain as components causing outgassing (outgassing induced by heating) in the acrylic polymer. Exemplary azo initiators include 2,2′-azobisisobutyronitrile (hereinafter also referred to as AIBN), 2,2′-azobis-2-methylbutyronitrile (hereinafter also referred to as AMBN), dimethyl 2,2′-azobis(2-methylpropionate), and 4,4′-azobis-4-cyanovalerianic acid. The amount of azo initiators is preferably from 0.05 to 0.5 parts by weight, and more preferably from 0.1 to 0.3 parts by weight, to the total amount (100 parts by weight) of monomer components configuring the acrylic polymer.

Solvents for use in polymerization of acrylic polymers through solution polymerization can be, for example, known or common organic solvents. Exemplary organic solvents include ester solvents such as ethyl acetate and methyl acetate; ketone solvents such as acetone and methyl ethyl ketone; alcohol solvents such as methanol, ethanol, and butanol; hydrocarbon solvents such as cyclohexane, hexane, and heptane; and aromatic solvents such as toluene and xylenes. Each of different organic solvents may be used alone or in combination.

The weight-average molecular weight of the acrylic polymers is preferably from 30×10⁴ to 200×10⁴, more preferably from 60×10⁴ to 150×10⁴, and furthermore preferably from 70×10⁴ to 150×10⁴. An acrylic polymer having a weight-average molecular weight of less than 30×10⁴ may not exhibit good adhesive properties; and in contrast, one having a weight-average molecular weight of more than 200×10⁴ may cause insufficient coatability; thus being undesirable. The weight-average molecular weight can be controlled by modifying the types and amounts of polymerization initiators, the temperature and duration of polymerization process, as well as the monomer concentration and the rate of dropwise addition of monomers.

The acrylic pressure-sensitive adhesive for the formation of the pressure-sensitive adhesive layers of the double-coated pressure-sensitive adhesive sheet may further contain one or more crosslinking agents for the purpose typically of controlling the gel fraction (proportion of components insoluble in the solvent) of the pressure-sensitive adhesive layers. Exemplary crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents are preferred as essential crosslinking agents, and, more preferably, one or more isocyanate crosslinking agents are used in combination with one or more epoxy crosslinking agents. Each of different crosslinking agents may be used alone or in combination.

Exemplary isocyanate crosslinking agents include lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanate, cyclohexylene diisocyanate, isophorone diisocyanate, hydrogenated tolylene diisocyanate, hydrogenated xylene diisocyanate, and hydrogenated xylylene diisocyanate; aromatic polyisocyanates such as 2,4-tolylene diisocyanate, 2,6-tolylene diisocyanate, 4,4′-diphenylmethane diisocyanate, and xylylene diisocyanate; as well as a trimethylolpropane/tolylene diisocyanate adduct [supplied by Nippon Polyurethane Industry Co., Ltd. under the trade name “Coronate L”] and a trimethylolpropane/hexamethylene diisocyanate adduct [supplied by Nippon Polyurethane Industry Co., Ltd. under the trade name “Coronate HL”].

Exemplary epoxy crosslinking agents include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, polyethylene glycol diglycidyl ethers, polypropylene glycol diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl) isocyanurate, resorcinol diglycidyl ether, and bisphenol-S diglycidyl ether; and epoxy resins each having two or more epoxy groups per one molecule. Exemplary commercial products usable as epoxy crosslinking agents include a product supplied by Mitsubishi Gas Chemical Company, Inc. under the trade name “TETRAD C”.

The content of crosslinking agents in the acrylic pressure-sensitive adhesive is preferably from 0.15 to 1.05 parts by weight, more preferably from 0.2 to 1.05 parts by weight, and furthermore preferably from 0.2 to 0.5 part by weight, per 100 parts by weight of the acrylic polymer.

Among such crosslinking agents, isocyanate crosslinking agents are preferably used in a content of from 0.15 to 1 part by weight, more preferably from 0.2 to 1 part by weight, and furthermore preferably from 0.2 to 0.5 part by weight, per 100 parts by weight of the acrylic polymer. An acrylic pressure-sensitive adhesive having a content of isocyanate crosslinking agents of less than 0.15 part by weight may cause the pressure-sensitive adhesive layers to exhibit an insufficient anchoring activity to the adherend, to thereby show a large split distance to cause “lifting”. In contrast, an acrylic pressure-sensitive adhesive having a content of isocyanate crosslinking agents of more than 1 part by weight may cause the pressure-sensitive adhesive layers to have an excessively high gel fraction and thereby have an excessively high repulsive force against bending, and the resulting adhesive sheet may show a large split distance and be liable to suffer from “lifting”.

The isocyanate crosslinking agents, if contained in a relatively low content, may not sufficiently help to control the gel fraction, because most of isocyanate crosslinking agents undergo crosslinking by themselves. In this case, one or more epoxy crosslinking agents are preferably used in combination. The content of epoxy crosslinking agents is preferably from 0 to 0.05 part by weight, and more preferably from 0 to 0.02 part by weight, per 100 parts by weight of the acrylic polymer. An acrylic pressure-sensitive adhesive having a content of epoxy crosslinking agents of more than 0.05 part by weight may cause the pressure-sensitive adhesive layers to have an excessively high gel fraction and thereby have an excessively high repulsive force against bending, and the resulting adhesive sheet may show a large split distance and be liable to suffer from “lifting”.

Where necessary, the acrylic pressure-sensitive adhesive may further contain, in addition to the above components, known additives within ranges not adversely affecting the characteristic properties. Exemplary additives include age inhibitors, fillers, colorants such as pigments and dyestuffs, ultraviolet-absorbers, antioxidants, plasticizers, softeners, surfactants, and antistatic agents.

The acrylic pressure-sensitive adhesive preferably contains substantially no tackifier resin. As used herein the term “contains substantially no” means that such tackifier resin is not positively incorporated, except for inevitable contamination. Specifically, the content of tackifier resins is preferably less than 1 percent by weight, and more preferably less than 0.1 percent by weight, based on the total weight of the acrylic pressure-sensitive adhesive (solid contents). An acrylic pressure-sensitive adhesive, if containing such tackifier resins, may cause outgassing when the pressure-sensitive adhesive layers are heated. Specific exemplary tackifier resins include rosin derivative resins, polyterpene resins, petroleum resins, and oil-soluble phenol resins.

A technique to form pressure-sensitive adhesive layers of the double-coated pressure-sensitive adhesive sheet is not particularly limited and may be suitably selected from among known techniques for forming pressure-sensitive adhesive layers. Specifically but merely by way of example, exemplary techniques include a direct application technique in which the acrylic pressure-sensitive adhesive (or a solution thereof) is applied to a predetermined surface (e.g., a surface of the base) to give a layer having a predetermined thickness after drying, and the applied layer is dried or cured according to necessity to form a pressure-sensitive adhesive layer; and a transfer technique in which the acrylic pressure-sensitive adhesive (or a solution thereof) is applied to a suitable release liner to give a layer having a predetermined thickness after drying, the applied layer is dried or cured according to necessity to form a pressure-sensitive adhesive layer, and the formed pressure-sensitive adhesive layer is transferred onto a predetermined surface (e.g., a surface of the base). The application or coating of the acrylic pressure-sensitive adhesive (or a solution thereof) may be conducted using a common coater. Exemplary coaters include gravure roll coaters, reverse roll coaters, kiss-roll coaters, dip roll coaters, bar coaters, knife coaters, and spray coaters.

The pressure-sensitive adhesive unit of the double-coated pressure-sensitive adhesive sheet can be prepared by forming pressure-sensitive adhesive layers on or above both sides of the plastic base film according to the technique for forming pressure-sensitive adhesive layers.

Though not critical, the thickness of each pressure-sensitive adhesive layer (the thickness of one of the two pressure-sensitive adhesive layers of the pressure-sensitive adhesive unit) is preferably from 4 to 29 μm, more preferably from 10 to 25 μm, and furthermore preferably from 15 to 20 μm. A pressure-sensitive adhesive layer having a thickness of less than 4 μm may not provide sufficient adhesiveness. In contrast, a pressure-sensitive adhesive layer having a thickness of more than 29 μm may cause an excessively large thickness of the double-coated pressure-sensitive adhesive sheet and may be disadvantageous for reduction in thickness and size of a product as manufactured while fixing a FPC through the double-coated pressure-sensitive adhesive sheet. Each of the pressure-sensitive adhesive layers may have a single-layer structure or multilayer-structure.

The gel fractions of the pressure-sensitive adhesive layers are preferably from 10% to 60% (percent by weight), more preferably from 10% to 50%, and further preferably from 15% to 50%. Controlling the gel fraction of the pressure-sensitive adhesive layers within the range makes the double-coated pressure-sensitive adhesive sheet to be resistant to “lifting” from an adherend, even when it is affixed to the adherend and then subjected to a heating process. Pressure-sensitive adhesive layers having a gel fraction of less than 10% may have an insufficient cohesive force and become susceptible to a cohesive failure, and this may cause insufficient adhesiveness and reworkability (e.g., prevention of an adhesive transfer upon peeling), thus being undesirable. In contrast, pressure-sensitive adhesive layers having a gel fraction of more than 60% may have excessively high repulsive force against bending and show a large split distance, and this may often cause “lifting” typically in bumped portions during or after a heating process, thus being undesirable. The gel fraction may be controlled, for example, by modifying the monomer composition of the acrylic polymer, and the types and contents of crosslinking agents.

The gel fraction (solvent-insoluble content) is determined, for example, according to the following “technique for measuring gel fraction”.

Technique for Measuring Gel Fraction

About 0.1 g of a pressure-sensitive adhesive layer of the double-coated pressure-sensitive adhesive sheet is sampled, covered by a porous tetrafluoroethylene sheet (supplied by Nitto Denko Corporation under the trade name “NTF 1122”) having an average pore size of 0.2 μm, tied with a kite string, the weight of the resulting article is measured, and this weight is defined as a “weight before immersion”. The “weight before immersion” is the total weight of the pressure-sensitive adhesive layer (the sampled pressure-sensitive adhesive layer), the tetrafluoroethylene sheet, and the kite string. Independently, the total weight of the tetrafluoroethylene sheet and the kite string is measured as a tare weight.

Next, the sampled pressure-sensitive adhesive layer covered by the tetrafluoroethylene sheet and tied with the kite stirring (hereinafter also referred to as “sample”) is placed in a 50-ml vessel filled with ethyl acetate, and left stand at 23° C. for one week (7 days). The sample after immersion in ethyl acetate is retrieved from the vessel, transferred into an aluminum cup, dried in a drier at 130° C. for 2 hours to remove ethyl acetate, and the weight of the resulting sample is measured as a weight after immersion.

A gel fraction is calculated according to the following equation:

Gel fraction (percent by weight)=(A−B)/(C−B)×100 (1)

wherein “A” represents the weight after immersion; “B” represents the tare weight; and “C” represents the weight before immersion.

Release Liners

The surfaces (adhesive faces) of the pressure-sensitive adhesive layers of the double-coated pressure-sensitive adhesive sheet may be protected by a release liner or liners (separators) before use. In this case, the two adhesive faces of the double-coated pressure-sensitive adhesive sheet may be protected by two release liners respectively; or the double-coated pressure-sensitive adhesive sheet may be wound into a roll so that the two adhesive faces are protected by one release liner having release surfaces on both sides. The release liner(s) is used as a protective material for the pressure-sensitive adhesive layers and is removed on or before the application of the double-coated pressure-sensitive adhesive sheet to the adherend. Such release liners are not necessarily provided.

Above all, the double-coated pressure-sensitive adhesive sheet preferably includes a release liner or liners on or above both surfaces (adhesive faces) of the pressure-sensitive adhesive unit. Namely, both adhesive faces of the pressure-sensitive adhesive unit are preferably protected by a release liner or liners. Such release liners for use in the double-coated pressure-sensitive adhesive sheet are preferably non-silicone release liners using no silicone release agent. If silicone release liners are used, silicone compounds attached to the adhesive faces or absorbed by the pressure-sensitive adhesive layers may evolve siloxane gas or cause contamination of the adherend with such siloxane gas, and thereby may often cause corrosion or a contact fault of electronic components used in a product, such as hard disk drives, manufactured while fixing a FPC through the double-coated pressure-sensitive adhesive sheet. Non-silicone release liners do not cause these problems and are preferably used herein.

The non-silicone release liners are not particularly limited, unless they use silicone release agents. Exemplary non-silicone release liners include base materials having a releasable layer; low-adhesive base materials made from fluorine-containing polymers; and low-adhesive base materials made from nonpolar polymers. Exemplary base materials having a releasable layer include plastic films and papers whose surface has been treated with a release agent such as a long-chain alkyl release agent, a fluorine-containing release agent, or molybdenum sulfide. Exemplary fluorine-containing polymers in the low-adhesive base materials made from fluorine-containing polymers include polytetrafluoroethylenes, polychlorotrifluoroethylenes, poly(vinyl fluoride)s, poly(vinylidene fluoride)s, tetrafluoroethylene/hexafluoropropylene copolymers, and chlorofluoroethylene/vinylidene fluoride copolymers. Exemplary nonpolar polymers in the low-adhesive base materials made from nonpolar polymers include olefinic resins such as polyethylenes and polypropylenes.

Among them, preferred are release liners having a releasably treated surface made from an olefinic resin (polyolefin release liners), of which release liners having a releasably treated surface made from a polyethylene (polyethylene release liners) are more preferred. The polyolefin release liners have only to have an olefinic resin layer to be a surface (releasably treated surface) in contact with an adhesive face, and may be, for example, a multilayer film including a polyester resin layer and an olefinic resin layer.

The olefinic resins are not especially limited, but preferred examples thereof include polyethylenes, of which linear low-density polyethylenes and low-density polyethylenes are more preferred; polypropylenes; polybutenes; poly(4-methyl-1-pentene)s; and ethylene-α-olefin copolymers (i.e., copolymers of ethylene and an α-olefin having 3 to 10 carbon atoms). Among them, more preferred are resin mixtures each containing at least two ethylenic polymers selected from the group consisting of linear low-density polyethylenes, low-density polyethylenes, and ethylene-α-olefin copolymers. Of such resin mixtures containing at least two ethylenic polymers, those containing at least a linear low-density polyethylene are preferred, and those containing a linear low-density polyethylene in combination with a low-density polyethylene and/or ethylene-α-olefin copolymer are more preferred.

A comonomer component for use with ethylene in the linear low-density polyethylenes can be chosen adequately and is preferably 1-hexene and/or 1-octene. Of the ethylene-α-olefin copolymers, preferred examples include ethylene-propylene copolymers and ethylene-(1-butene) copolymers.

The release liners can be formed according to a known or common procedure. The thicknesses and other dimensions or properties of the release liners are not critical.

When the double-coated pressure-sensitive adhesive sheet includes a release liner or liners on or above both adhesive faces of the pressure-sensitive adhesive unit, it is preferred that a release force between the pressure-sensitive adhesive unit and a release liner present on or above one adhesive face of the pressure-sensitive adhesive unit differs from a release force between the pressure-sensitive adhesive unit and a release liner present on or above the other adhesive face, because this improves the workability such as peel workability. The release force between the pressure-sensitive adhesive unit and the release liner on a side with a less release force (more peelable side) (hereinafter referred to as “release force of the more peelable side”) is preferably from 0.01 to 0.3 newtons per 50 millimeters (N/50 mm), more preferably from 0.05 to 0.3 N/50 mm, and further preferably from 0.1 to 0.3 N/50 mm. On the other hand, the release force between the pressure-sensitive adhesive unit and the release liner on a side with a more release force (less peelable side) (hereinafter referred to as “release force of the less peelable side”) is preferably from 0.1 to 2 N/50 mm, and more preferably from 0.5 to 1 N/50 mm. The difference between the release force of the more peelable side and that of the less peelable side (difference in release force) is preferably 0.05 N/50 mm or more, and more preferably from 0.1 to 1 N/50 mm. The difference in release force is represented by the formula: [(release force of the less peelable side)-(release force of the more peelable side)]. As used herein the term “release force” refers to a 180-degree peel strength (180-degree peel adhesion) of the release liner with respect to the pressure-sensitive adhesive unit as measured in a 180-degree peel test in accordance with Japanese Industrial Standards (JIS) Z0237.

Exemplary factors to control the release forces include the surface roughness (arithmetic mean surface roughness) of the release layer surface (the surface of the side to be in contact with the adhesive face of the pressure-sensitive adhesive unit) of the release liner, and the types of the release agent.

Exemplary preferred release liners for use as the more peelable side include polyolefin release liners having a release layer (releasable layer) made from a polyolefinic resin and having a rough or embossed surface, such as the release liner described in Japanese Unexamined Patent Application Publication (JP-A) No. 2005-350650. The rough surface of the release layer preferably includes embossed or roughened portions with irregularly different shapes arranged in an irregular positional relationship. Though not critical, the surface roughness (arithmetic mean surface roughness) Ra of the release layer is, for example, preferably from 0.5 to 5 μm, more preferably from 1 to 3 μm, and furthermore preferably from 1.5 to 2 μm. These ranges are preferred typically from the viewpoints of the releasability and airtightness between the release layer and the pressure-sensitive adhesive layer. Also though not critical, the maximum surface roughness amplitude Rt of the release layer is, for example, preferably from 1 to 15 μm, more preferably from 3 to 10 μm, and furthermore preferably from 4 to 8 μm.

In contrast, exemplary preferred release liners for use as the less peelable side include polyolefin release liners having a release layer without such a rough surface, such as the release liner described in Japanese Patent No. 3901490.

Properties of Double-Coated Pressure-Sensitive Adhesive Sheet

The double-coated pressure-sensitive adhesive sheet according to the present invention structurally includes at least the pressure-sensitive adhesive unit. The double-coated pressure-sensitive adhesive sheet preferably further structurally includes the release liner or liners on or above both surfaces of the pressure-sensitive adhesive unit. Namely, the double-coated pressure-sensitive adhesive sheet preferably has a structure of (release liner)/(pressure-sensitive adhesive unit)/(release liner).

The double-coated pressure-sensitive adhesive sheet shows an outgassing (total outgassing: total amount of evolved outgases) of 1 μg/cm² or less, preferably 0.8 μg/cm² or less, and more preferably 0.4 μg/cm² or less. The outgassing herein is determined while heating the sheet at a temperature of 120° C. for 10 minutes and measuring the total amount of evolved gases according to the following measuring technique. Specifically, the amount of outgas (outgassing) of the double-coated pressure-sensitive adhesive sheet is determined in such a manner that the release liner is removed from the both sides of the double-coated pressure-sensitive adhesive sheet (when the double-coated pressure-sensitive adhesive sheet includes release liners on or above both sides of the pressure-sensitive adhesive unit, the both release liners are removed); a poly(ethylene terephthalate) (PET) film as a backing is affixed to either one adhesive face of the pressure-sensitive adhesive unit; and the outgassing evolved from the other adhesive face bearing no backing PET film is measured. A double-coated pressure-sensitive adhesive sheet showing an outgassing of 1 μg/cm² or less does not cause corrosion and malfunction of electronic devices, such as hard disk drives, due to outgas components and is superior in long-term reliability even when it is adopted to fix a FPC in the electronic devices. These outgases are generally derived from silicone release agents in release liners and unreacted monomer components in pressure-sensitive adhesives. Thus, outgassing can be reduced in the present invention, for example, by using non-silicone release liners. The outgassing can also be reduced typically by controlling, within preferred ranges, the types of polymerization initiators for the acrylic polymer for use in the pressure-sensitive adhesive and molecular weight of the acrylic polymer for use in the pressure-sensitive adhesive. It is preferred that the outgassing falls within the above-specified range when any of the two adhesive faces of the double-coated pressure-sensitive adhesive sheet is subjected to the measurement.

The split distance of the double-coated pressure-sensitive adhesive sheet according to the present invention is 1.5 mm or less, preferably from 0 to 1 mm, and more preferably from 0 to 0.8 mm. A double-coated pressure-sensitive adhesive sheet, if having a split distance of more than 1.5 mm, may have an insufficient bond strength against repulsive force after warming or heating when adopted to fix a flexible printed circuit board, and it may be liable to suffer from “lifting” of the FPC when the FPC is attached to an adherend through the double-coated pressure-sensitive adhesive sheet and thereafter heated or warmed.

The split distance is determined in the following manner: A test specimen is prepared by affixing one adhesive face of the double-coated pressure-sensitive adhesive sheet (10 mm wide and 90 mm long) to one entire side of an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-coated pressure-sensitive adhesive sheet in the test specimen is affixed to an adherend through compression bonding using a roll laminator, where the adherend is a flat plate prepared by affixing a polyimide film to a polypropylene sheet 2 mm thick, and the other adhesive face is affixed to the polyimide film of the adherend; the resulting article is left stand at 23° C. for 24 hours, thereafter heated or warmed at 70° C. for 2 hours, and the height (mm) of an end of the test specimen lifted or raised from the adherend surface is measured and defined as “split distance” (mm). More specifically, the split distance can be measured by the method described in “(4) Split Distance (at 70° C. for 2 hours)” in “Evaluations” mentioned below. It is preferred that the split distance falls within the above range when any of the two adhesive faces of the double-coated pressure-sensitive adhesive sheet is affixed to the aluminum plate to be measured.

The double-coated pressure-sensitive adhesive sheet according to the present invention is a double-coated pressure-sensitive adhesive sheet adopted to fix a flexible printed circuit board (FPC) to an adherend (double-coated pressure-sensitive adhesive sheet for fixing a flexible printed circuit board). Exemplary adherends to which the FPC is affixed through the double-coated pressure-sensitive adhesive sheet include, but are not limited to, cabinets of cellular phones, motors, bases, substrates, and covers. Affixing and securing a FPC to the adherend through the double-coated pressure-sensitive adhesive sheet gives products such as hard disk drives, cellular phones, and motors. The double-coated pressure-sensitive adhesive sheet can suppress “lifting” of the FPC from the adherend even after a process such as baking (e.g., at a heating temperature of about 90° C.) for resin curing, in which such “lifting” occurs due typically to bumps caused by conductors. Additionally, the double-coated pressure-sensitive adhesive sheet does not cause contamination of the adherend with outgas, and gives products (e.g., hard disk drives) that are satisfactorily reliable and have high quality.

Though not limited, the flexible printed circuit board (FPC) includes an electrical insulating (dielectric) layer (hereinafter also referred to as a “base insulating layer”), an electroconductive layer (hereinafter also referred to as a “conductive layer”) arranged as a predetermined circuit pattern on or above the base insulating layer, and, where necessary, a covering electrical insulating layer (hereinafter also referred to as a “cover insulating layer”) arranged on or above the conductive layer. The flexible printed circuit board may have a multilayer structure in which two or more circuit substrates are stacked.

The base insulating layer is an electrical insulating layer prepared from an electrically insulating material. The electrically insulating material to form the base insulating layer is not especially limited and can be suitably chosen from among electrically insulating materials for use in known flexible printed circuit boards. Preferred examples of such electrically insulating materials are plastic materials such as polyimide resins, acrylic resins, poly(ether nitrile) resins, poly(ether sulfone) resins, polyester resins (e.g., poly(ethylene terephthalate)s and poly(ethylene naphthalate)s), polyvinyl chloride) resins, poly(phenylene sulfide) resins, poly(ether ether ketone) resins, polyamide resins (e.g., so-called “aramid resins”), polyarylate resins, polycarbonate resins, and liquid crystal polymers. Each of different electrically insulating materials can be used alone or in combination. Among them, polyimide resins are more preferred. The base insulating layer may have a single-layer structure or multilayer structure. The surface of the base insulating layer may have been subjected to various surface treatments such as corona discharge treatment, plasma treatment, surface roughening, and hydrolyzing. Though not critical, the thickness of the base insulating layer is preferably from 3 to 100 μm, more preferably from 5 to 50 μm, and furthermore preferably from 10 to 30 μm.

The conductive layer is an electroconductive layer prepared from an electroconductive material. The conductive layer is arranged on or above the base insulating layer to form a predetermined circuit pattern. The electroconductive material to form the conductive layer is not especially limited and can be suitably chosen from among electroconductive materials for use in known flexible printed circuit boards. Exemplary electroconductive materials include metallic materials such as copper, nickel, gold, and chromium, as well as alloys (for example, solder) and platinum; and electroconductive plastic materials. Each of different electroconductive materials can be used alone or in combination. Among them, metallic materials are preferred, of which copper is especially preferred. The conductive layer may have a single-layer structure or multilayer structure. The surface of the conductive layer may have been subjected to various surface treatments. Though not critical, the thickness of the conductive layer is preferably from 1 to 50 μm, more preferably from 2 to 30 μm, and furthermore preferably from 3 to 20 μm.

The way to form the conductive layer is not especially limited and can be chosen from among known formation techniques for conductive layers, including known patterning processes such as subtractive process, additive process, and semi-additive process. Typically, when to be arranged directly on the surface of the base insulating layer, the conductive layer can be provided by forming a layer of an electroconductive material as a predetermined circuit pattern on the base insulating layer typically through plating or vapor deposition. Exemplary techniques usable herein include electroless plating, electrolytic plating, vacuum vapor deposition, and sputtering.

The cover insulating layer is a covering electrical insulating layer (protective electrical insulating layer) which is prepared from an electrically insulating material and covers the conductive layer. The cover insulating layer is provided according to necessity and is not necessarily provided. The electrically insulating material to form the cover insulating layer is not especially limited and can be chosen from among electrically insulating materials for use in known flexible printed circuit boards, as in the base insulating layer. Specific examples of electrically insulating materials for the formation of the cover insulating layer include the electrically insulating materials listed above as the electrically insulating materials for the formation of the base insulating layer. Among them, plastic materials are preferred, of which polyimide resins are more preferred, as in the base insulating layer. Each of different electrically insulating materials can be used alone or in combination for the formation of the cover insulating layer. The cover insulating layer may have a single-layer structure or multilayer structure. The surface of the cover insulating layer may have been subjected to various surface treatments such as corona discharge treatment, plasma treatment, surface roughening, and hydrolyzing. Though not critical, the thickness of the cover insulating layer is preferably from 3 to 100 μm, more preferably from 5 to 50 μm, and furthermore preferably from 10 to 30 μm.

The way to form the cover insulating layer is not especially limited and can be suitably chosen from among known formation techniques. Exemplary formation techniques include a technique of applying a layer of a liquid or melt containing an electrically insulating material, and drying the applied layer; and a technique of previously forming a film or sheet corresponding to the dimensions of the conductive layer and including an electrically insulating material, and laying the film or sheet on the conductive layer.

### EXAMPLES

The present invention will be illustrated in further detail with reference to several examples below. It should be noted, however, that these are illustrated only by way of example and are never construed to limit the scope of the present invention.

### Example 1

A solution (solids concentration: 25 percent by weight) of an acrylic polymer (hereinafter referred to as “Acrylic Polymer 1”) having a weight-average molecular weight of 150×10⁴ was prepared by subjecting 93 parts by weight of butyl acrylate, 7 parts by weight of acrylic acid, and 0.05 part by weight of 4-hydroxybutyl acrylate to solution polymerization according to a common procedure while using ethyl acetate as a solvent and 0.1 part by weight of azobisisobutyronitrile as an initiator. The solution was combined with 0.4 part by weight (in terms of solids content) of an isocyanate crosslinking agent per 100 parts by weight of the acrylic polymer and thereby yielded a pressure-sensitive adhesive solution (acrylic pressure-sensitive adhesive solution). The isocyanate crosslinking agent was a product supplied by Nippon Polyurethane Industry Co., Ltd. under the trade name “CORONATE L” as a tolylene diisocyanate adduct of trimethylolpropane and had a solids concentration of 75 percent by weight.

The above-prepared pressure-sensitive adhesive solution was applied to both surfaces of a poly(ethylene terephthalate) film (supplied by Toray Industries, Inc. under the trade name “Lumirror S-10”, 12 μm thick), dried at 120° C. for 3 minutes to form pressure-sensitive adhesive layers, and thereby yielded a pressure-sensitive adhesive unit having a thickness of 50 μm. The thickness herein is the thickness from the surface of one pressure-sensitive adhesive layer to the surface of the other pressure-sensitive adhesive layer. Each of the two pressure-sensitive adhesive layers had a thickness of 19 μm. The gel fraction of the pressure-sensitive adhesive layers is as shown in Table 1. In this connection, the two pressure-sensitive adhesive layers have an equal gel fraction to each other.

A release liner (release liner “a”) was prepared in the following manner. Initially, an anchor coating agent (primer) solution was prepared by blending 100 parts by weight of an ester urethane anchor coating agent (supplied by Toyo-Morton, Ltd. under the trade name “AD-527”) with 7 parts by weight of a curing accelerator (supplied by Toyo-Morton, Ltd. under the trade name “CAT HY-91”) and thereafter adding ethyl acetate to give a solution having a solids concentration of 5 percent by weight. The anchor coating agent solution was applied to a poly(ethylene terephthalate) film (supplied by Toray Industries, Inc. under the trade name “Lumirror S-105-50”, 50 μm thick) using a roll coater to form a layer about 1 μm thick, and the applied layer was dried at 80° C. to give an anchor coating layer 0.1 μm thick. A layer of low-density polyethylene (supplied by Asahi Kasei Corporation under the trade name “L-1850A”) was laminated onto the anchor coating layer through extrusion at a temperature below the die of 325° C. according to a tandem system to give an undercoat layer 10 μm thick. Independently, a resin composition was prepared by mixing 100 parts by weight of a resin mixture containing a linear low-density polyethylene as a principal component (supplied by Prime Polymer Co., Ltd. under the trade name “MORETEC (registered trademark) 0628D”) with 150 parts by weight of an ethylene-propylene copolymer (supplied by Mitsui Chemicals, Inc. under the trade name “TAFMER (registered trademark) P0180”). Subsequently, a layer of the resin composition (release layer component) was laminated onto the undercoat layer through extrusion at a temperature below the die of 273° C. to give a release layer 10 μm thick, and the extruded release layer was finely embossed by cooling the layer using an embossed cooling mat roll as a cooling roll to give a release layer having an embossed or roughened surface (surface-embossed release layer). Thus, a release liner (release liner “a”) having a total thickness of about 70 μm was prepared.

The embossed surface of the surface-embossed release layer includes embossed or roughened portions with irregularly different shapes arranged in an irregular positional relationship. The surface-embossed release layer had an arithmetic mean surface roughness (Ra) of 1.5 μm and a maximum surface roughness amplitude (Rt) of 4

Independently, another release liner (release liner “b”) was prepared in the following manner. Initially, an anchor coating agent (primer) solution was prepared by blending 100 parts by weight of an ester urethane anchor coating agent (supplied by Toyo-Morton, Ltd. under the trade name “AD-527”) with 7 parts by weight of a curing accelerator (supplied by Toyo-Morton, Ltd. under the trade name “CAT HY-91”) and thereafter adding ethyl acetate to give a solution having a solids concentration of 5 percent by weight. The anchor coating agent solution was applied to a poly(ethylene terephthalate) film (supplied by Toray Industries, Inc. under the trade name “Lumirror S-105-50”, 50 μm thick) using a roll coater to give a layer about 1 μm, and the applied layer was dried at 80° C. to give an anchor coating layer 0.1 μm thick. A layer of low-density polyethylene (supplied by Asahi Kasei Corporation under the trade name “L-1850A”) was laminated onto the anchor coating layer through extrusion at a temperature below the die of 325° C. according to a tandem system to give an undercoat layer 10 μm thick. Independently, a resin composition was prepared by mixing 100 parts by weight of a resin mixture containing a linear low-density polyethylene as a principal component (supplied by Prime Polymer Co., Ltd. under the trade name “MORETEC (registered trademark) 0628D”) with 10 parts by weight of an ethylene-propylene copolymer (supplied by Mitsui Chemicals, Inc. under the trade name “TAFMER (registered trademark) P0180”). Subsequently, a layer of the resin composition (release layer component) was laminated onto the undercoat layer through extrusion at a temperature below the die of 273° C. to give a release layer 10 μm thick. Thus, the release liner (release liner “b”) having a total thickness of about 70 μm was prepared.

Next, the release liner “a” (more peelable side) was applied to one adhesive face of the pressure-sensitive adhesive unit and the release liner “b” (less peelable side) was applied to the other adhesive face so that the releasable layers (release layers) were in contact with the adhesive faces, respectively, to give a double-coated pressure-sensitive adhesive sheet.

### Example 2

A double-coated pressure-sensitive adhesive sheet was prepared by the procedure of Example 1, except for using the isocyanate crosslinking agent in the amount given in Table 1 and further using a multifunctional epoxy crosslinking agent (supplied by Mitsubishi Gas Chemical Company, Inc. under the trade name “TETRAD C”) as an additional crosslinking agent in the pressure-sensitive adhesive solution.

In Table 1, the “amount (part by weight)” of the isocyanate crosslinking agent (CORONATE L) is indicated as the “amount (part by weight) in terms of solids content of CORONATE L per 100 parts by weight of the acrylic polymer”; and the “amount (part by weight)” of the epoxy crosslinking agents (TETRAD C) is indicated as the “amount (part by weight) of TETRAD C itself (the whole quantity of the product) per 100 parts by weight of the acrylic polymer”.

### Examples 3 and 4, Comparative Example 3

A series of double-coated pressure-sensitive adhesive sheets was prepared by the procedure of Example 2, except for modifying the thickness of a poly(ethylene terephthalate) film as a plastic base film and modifying the thickness of the pressure-sensitive adhesive layer.

### Comparative Example 1

A solution (solids concentration: 20 percent by weight) of an acrylic polymer (hereinafter referred to as “Acrylic Polymer 2”) having a weight-average molecular weight of 100×10⁴ was prepared by subjecting 90 parts by weight of 2-ethylhexyl acrylate and 10 parts by weight of acrylic acid to solution polymerization according to a common procedure using ethyl acetate as a solvent and 0.5 part by weight of benzoyl peroxide as an initiator.

A double-coated pressure-sensitive adhesive sheet was prepared by the procedure of Example 1, except for using Acrylic Polymer 2 instead of Acrylic Polymer 1, and using the crosslinking agent in the amount given in Table 1.

### Comparative Example 2

By the procedure of Comparative Example 1, a solution (solids concentration: 20 percent by weight) of an acrylic polymer (i.e., “Acrylic Polymer 2”) having a weight-average molecular weight of 100×10⁴ was prepared by subjecting 90 parts by weight of 2-ethylhexyl acrylate and 10 parts by weight of acrylic acid to solution polymerization according to a common procedure using ethyl acetate as a solvent and 0.5 part by weight of benzoyl peroxide as an initiator. The solution was combined with 2 parts by weight (in terms of solids content) of an isocyanate crosslinking agent (supplied by Nippon Polyurethane Industry Co., Ltd. under the trade name “CORONATE L”) per 100 parts by weight of the acrylic polymer, to give a pressure-sensitive adhesive solution (acrylic pressure-sensitive adhesive solution).

A release liner used herein was a release liner including a glassine paper, and on surface thereof, a releasable layer formed from a silicone release agent (release liner “c”).

Next, a base-less (carrier-less; double-faced) pressure-sensitive adhesive sheet was prepared by forming a pressure-sensitive adhesive layer and applying two plies of the release liner “c” to both sides of the pressure-sensitive adhesive layer, as shown in Table 1. Specifically, the double-faced pressure-sensitive adhesive sheet was prepared in the following manner. A layer of the above-prepared pressure-sensitive adhesive solution was applied to the releasable surface (releasable layer surface) of the release liner “c”, and the applied layer was dried at 120° C. for 3 minutes to give a pressure-sensitive adhesive layer 50 μm thick. In this article, the release liner plays a role as a less peelable side. Thereafter another ply of the release liner “c” (as a more peelable side) was applied to the other adhesive face of the pressure-sensitive adhesive layer opposite to the former release liner “c” so that the releasable layer was in contact with the adhesive face to give the double-faced pressure-sensitive adhesive sheet.

### Comparative Examples 4 and 5

A series of double-coated pressure-sensitive adhesive sheets was prepared by the procedure of Example 1, except for using the crosslinking agent in the amount given in Table 1.

### Evaluations

The double-coated (or double-faced) pressure-sensitive adhesive sheets prepared according to the examples and comparative examples were subjected to measurements and evaluations according to measurement methods and evaluation methods described below. The results of measurements and evaluations are shown in Table 1.

### (1) Outgassing

The release liner of the more peelable side was removed from each of the double-coated pressure-sensitive adhesive sheets prepared according to the examples and comparative examples, and a poly(ethylene terephthalate) film (supplied by Toray Industries, Inc. under the trade name “Lumirror S-10”, 25 μm thick) was affixed to the exposed adhesive face.

The double-coated pressure-sensitive adhesive sheet bearing the PET film affixed on one side thereof was cut into a piece of 1 cm wide and 7 cm long, from which the release liner of the less peelable side was removed, to give a test specimen.

The test specimen was heated at 120° C. for 10 minutes in a purge and trap headspace sampler, an evolved gas was trapped, and the trapped components were analyzed by gas chromatograph/mass spectrometer. The amount of evolved gas (outgassing) was converted in terms of n-decane, and the outgassing was calculated as the amount of outgas per unit area (in unit of μg/cm²).

(2) Adhesive Strength (180-degree peel, with respect to SUS 304BA stainless steel)

A strip specimen 20 mm wide and 150 mm long was prepared from each of the double-coated pressure-sensitive adhesive sheets prepared according to the examples and comparative examples.

The specimen was subjected to a 180-degree peel test using a tensile tester according to the method specified in JIS 20237 to measure a 180-degree peel strength (N/20 mm) from a test plate (SUS 304BA stainless steel plate), and the measured 180-degree peel strength was defined as the “adhesive strength”.

The affixation of the sample to the test plate was conducted in the following manner: the release liner of the more peelable side was removed from each of the prepared double-coated pressure-sensitive adhesive sheets to expose a surface; a PET film 25 μm thick was affixed (lined) to the exposed surface; the other release liner of the less peelable side was then removed to expose another surface; this exposed surface was laid on the test plate; and a 2-kg rubber roller (about 45 mm wide) was placed thereon and moved in one reciprocating manner.

The measurement was conducted under conditions in an atmosphere of a temperature of 23° C. and relative humidity of 50% at a peel angle of 180 degrees and a tensile speed of 300 mm per minute, and an adhesive strength was calculated. The test was conducted three times per sample, and the average of the three measurements was defined as the adhesive strength.

### (3) Release Force of Release Liners

A strip sheet piece 50 mm wide and 150 mm long was cut from each of the double-coated pressure-sensitive adhesive sheets prepared according to the examples and comparative examples and used as a test specimen for the measurement of a release force of the more peelable side. For the measurement of a release force of the less peelable side, the release liner of the more peelable side was removed, and a PET film 25 μm thick was affixed (lined) to the exposed surface to give a test specimen.

Each of the test specimens was subjected to a 180-degree peel test using a tensile tester according to the method specified in JIS 20237 to measure a 180-degree peel strength (N/50 mm) of each release liner, and the measured 180-degree peel strength was defined as a “release force of release liner”.

The measurement was conducted under conditions in an atmosphere of a temperature of 23° C. and relative humidity of 50% at a peel angle of 180 degrees and a tensile speed of 300 mm per minute, and an adhesive strength was calculated. The test was conducted three times (n=3), and the average of the three measurements was defined as the release force.

Tests were conducted on both the release liners of the less peelable side and of the more peelable side. In the measurement of a release force of the release liner of the less peelable side, the adhesive face on which the release liner of the more peelable side had been arranged was lined (backed) with a PET film, as described above.

(4) Split Distance (at 70° C. for 2 hours)

A test specimen was prepared by removing a release liner of the more peelable side from each of the double-coated pressure-sensitive adhesive sheets prepared according to the examples and comparative examples (size: 10 mm wide and 90 mm long) to expose an adhesive face, and affixing the exposed adhesive face (more peelable side) to an aluminum sheet 0.5 mm thick, 10 mm wide, and 90 mm long. The test specimen was placed in its longitudinal direction along a round rod having a diameter of 50 mm and bent into an arc so that the pressure-sensitive adhesive sheet faced outward; the release liner of the less peelable side was removed from the test specimen to expose the adhesive face of the less peelable side; and this exposed adhesive face was affixed to an adherend through compression bonding using a roll laminator. The adherend was a sheet prepared by affixing a polyimide film “Kapton 100H” to a polypropylene (PP) sheet 2 mm thick through a pressure-sensitive adhesive tape, and the pressure-sensitive adhesive layer was affixed to the polyimide film of the adherend. The resulting article was left stand in an environment of 23° C. for 24 hours, thereafter heated at 70° C. for 2 hours, and the heights (mm) of both ends of the test specimen split and raised from the adherend surface were measured and averaged as a split distance (mm).

### (5) Processability Test

A specimen for processability evaluation was prepared by half-cutting each of the double-coated pressure-sensitive adhesive sheets prepared according to the examples and comparative examples from the release liner “b” side using a pressing machine, whereby only the release liner “b” and the pressure-sensitive adhesive unit were notched. The specimen for processability evaluation was left in an atmosphere at a temperature of 60° C. and relative humidity of 90% for one week, and whether an autohesion of the cut surfaces occurred was observed, and the processability (processing suitability) was evaluated according to the criteria mentioned below.

Regarding Comparative Example 2, the double-coated pressure-sensitive adhesive sheet was half-cut from the release liner of the less peelable side, and evaluation was conducted in the same manner as above.

Criteria for Processability

Good: No autohesion was observed at the cut surfaces.

Poor: Autohesion was observed at the cut surfaces.

### (6) Fittability Around Bumps

The release liner of the more peelable side was removed from each of the double-coated pressure-sensitive adhesive sheets prepared according to the examples and comparative examples (size: 40 mm wide and 40 mm long) to expose an adhesive face, and the exposed adhesive face was applied to a surface of a base film layer of a FPC mentioned below through compression bonding under conditions at a temperature of 60° C. and a pressure of 2 MPa for 10 seconds. After compression bonding, the resulting article was observed from the double-coated pressure-sensitive adhesive sheet side with a microscope of a magnification of 50 times. A sample showing less “adhesion failure (lifting)” between the double-coated pressure-sensitive adhesive sheet and the base film layer typically in portions with bumps was evaluated as having good fittability around bumps; and one showing more “adhesion failure” was evaluated as having poor fittability around bumps.

[FPC (Adherend)]

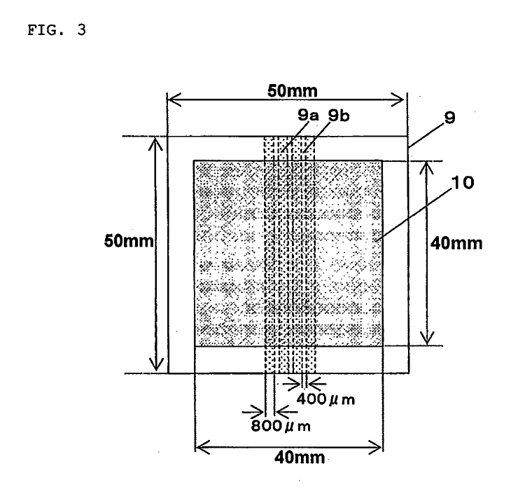

FIG. 2 is an explanatory drawing (schematic cross-sectional view) of a multilayer structure of the FPC used as the adherend above. FIG. 3 is an explanatory drawing (plan view when viewed from the base film layer side) illustrating how and where the double-coated pressure-sensitive adhesive sheet (test sample) was affixed to the FPC.

The FPC structurally includes a base insulating layer; a copper foil layer (conductor layer) 6 arranged on the base insulating layer; and a covering insulating layer arranged on the copper foil layer 6. The base insulating layer has a multilayer structure including a polyimide base film layer 4 and an epoxy adhesive layer 5. The covering insulating layer has a multilayer structure including a polyimide cover lay film layer 8 and an epoxy adhesive layer 7. The base film layer 4 has a thickness of 0.025 mm, the adhesive layer 5 has a thickness of 0.015 mm, the copper foil layer 6 has a thickness of 0.035 mm, the cover lay adhesive layer 7 has a thickness of 0.025 mm, and the cover lay film layer 8 has a thickness of 0.025 mm.

The copper foil layer is formed so as to have four linear circuit traces each having a width of the copper foil (line width) of 800 μm and a width of a space between adjacent copper foils of 400 μm. The surface of the base film layer of the FPC has bumps (steps) caused by the copper foil lines and spaces between the copper foil lines in the copper foil layer.

The double-coated pressure-sensitive adhesive sheet (test sample) 10 was affixed to the surface of the base film layer of the FPC (adherend) 9 as illustrated in FIG. 3. In FIG. 3, “9a” stands for a portion where the copper foil is arranged, and “9b” stands for a portion where the copper foil is not arranged.

TABLE 1

| | | | | | | Com. | Com. | Com. | Com. | Com. |
|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex. 5 |
| Plastic base film (thickness) | | PET film | PET film | PET film | PET film | PET film | None | PET film | PET film | PET film |
| | | (12 μm) | (12 μm) | (9 μm) | (4 μm) | (12 μm) | | (16 μm) | (12 μm) | (12 μm) |
| Pressure- | Acrylic polymer | Acrylic | Acrylic | Acrylic | Acrylic | Acrylic | Acrylic | Acrylic | Acrylic | Acrylic |
| sensitive | | polymer 1 | polymer 1 | polymer 1 | polymer 1 | polymer 2 | polymer 2 | polymer 1 | polymer 1 | polymer 1 |
| adhesive | Amount of epoxy | 0 | 0.01 | 0.01 | 0.01 | 0 | 0 | 0.01 | 0 | 0 |
| layer | crosslinking agent | | | | | | | | | |
| | (part by weight) | | | | | | | | | |
| | Amount of isocyanate | 0.4 | 0.2 | 0.2 | 0.2 | 1 | 2 | 0.2 | 2 | 0.1 |
| | crosslinking agent | | | | | | | | | |
| | (part by weight) | | | | | | | | | |
| | Thickness of pressure | 19 | 19 | 20.5 | 23 | 19 | — | 17 | 19 | 19 |
| | sensitive layer | | | | | | | | | |
| | (one layer) (μm) | | | | | | | | | |
| Thickness of pressure-sensitive | | 50 | 50 | 50 | 50 | 50 | 50 | 50 | 50 | 50 |
| adhesive unit (μm) | | | | | | | | | | |
| Release liner | | Non- | Non- | Non- | Non- | Non- | Silicone, | Non- | Non- | Non- |
| | | silicone, | silicone, | silicone, | silicone, | silicone, | both | silicone, | silicone, | silicone, |
| | | both | both | both | both | both | sides | both | both | both |
| | | sides | sides | sides | sides | sides | | sides | sides | sides |
| Gel fraction (%) of pressure- | | 18 | 40 | 40 | 40 | 38 | 70 | 40 | 85 | 0 |
| sensitive adhesive layer | | | | | | | | | | |
| Split distance (mm) (at 70° C. | | 0.5 | 0.5 | 0.5 | 0.5 | 0.6 | 1.3 | 1.2 | 1.8 | 10.3 |
| for 2 hr) | | | | | | | | | | |
| Outgassing (μg/cm²) | | 0.18 | 0.17 | 0.5 | 0.6 | 2.3 | 15 | 0.15 | 0.4 | 0.2 |
| Adhesive strength (N/20 mm) | | 8.7 | 9.0 | 10.0 | 10.0 | 8.2 | 8.6 | 6.0 | 7.0 | 8.4 |
| (180-degree peel, to SUS | | | | | | | | | | |
| 304BA steel sheet) | | | | | | | | | | |
| Release | More peelable side | 0.18 | 0.16 | 0.2 | 0.2 | 0.29 | 0.1 | 0.15 | 0.08 | 0.2 |
| force of | (N/50 mm)) | | | | | | | | | |
| release | Less peelable side | 0.85 | 0.93 | 1 | 1 | 0.66 | 0.3 | 0.8 | 0.8 | 0.9 |
| liner | (N/50 mm) | | | | | | | | | |

| | | | | | | | | | |
|---|---|---|---|---|---|---|---|---|---|
| Processability | Good | Good | Good | Good | Good | Poor | Good | Good | Good |
| Fittability around bumps | Good | Good | Good | Good | Good | Good | Poor | Good | Good |

Acrylic Polymer 1: Butyl acrylate (93 parts by weight)/acrylic acid (7 parts by weight)/hydroxybutyl acrylate (0.05 part by weight), with azobisisobutyronitrile initiator
Acrylic Polymer 2: 2-Ethylhexyl acrylate (90 parts by weight)/acrylic acid (10 parts by weight) with benzoyl peroxide initiator
Epoxy crosslinking agent trade name “TETRAD-C” supplied by Mitsubishi Gas Chemical Company, Inc.
Isocyanate crosslinking agent trade name “Coronate L” supplied by Nippon Polyurethane Industry Co., Ltd.

The evaluation results in Table 1 demonstrate that the double-coated pressure-sensitive adhesive sheets according to the present invention (Examples 1 to 4) cause less outgassing, show less split distances, and, in addition, excel in processability (processing suitability) and fittability around bumps.

In contrast, the evaluation results also demonstrate that the double-coated pressure-sensitive adhesive sheet having a thickness of plastic base film of more than 13 μm (Comparative Example 3) has poor fittability around bumps; and the base-less pressure-sensitive adhesive sheet using no plastic base film (Comparative Example 2) has unsatisfactory processability.

While the above description is of the preferred embodiments of the present invention, it should be appreciated that the invention may be modified, altered, or varied without deviating from the scope and fair meaning of the following claims.

1. A double-coated pressure-sensitive adhesive sheet for fixing a flexible printed circuit board, comprising at least a pressure-sensitive adhesive unit including:
a plastic base film having a thickness of 13 μm or less;
a first pressure-sensitive adhesive layer present on or above one surface of the plastic base film; and
a second pressure-sensitive adhesive layer present on or above the other surface of the plastic base film,
wherein each of the first and second pressure-sensitive adhesive layers includes an acrylic polymer containing one or more polar-group-containing monomers and one or more alkyl (meth)acrylates whose alkyl moiety being a linear or branched-chain alkyl group having 2 to 14 carbon atoms as essential monomer components, and
wherein the pressure-sensitive adhesive unit has a thickness of 60 μm or less, and wherein the double-coated pressure-sensitive adhesive sheet shows an outgassing of 1 microgram per square centimeter (μg/cm²) or less when heated at 120° C. for 10 minutes, and shows a split distance as defined below of 1.5 mm or less;
Split Distance: a test specimen is prepared by affixing one adhesive face of the double-coated pressure-sensitive adhesive sheet to an aluminum sheet 0.5 mm thick, 10 mm wide, and 90 mm long; the test specimen is bent in a longitudinal direction thereof into an arc along a round rod having a diameter of 50 mm so that the pressure-sensitive adhesive sheet faces outward; and the other adhesive face of the double-coated pressure-sensitive adhesive sheet is affixed to an adherend through compression bonding using a roll laminator, where the adherend is a sheet prepared by affixing a polyimide film to a polypropylene sheet 2 mm thick, and the other adhesive face is affixed to the polyimide film of the adherend; the resulting article is left stand at 23° C. for 24 hours, thereafter heated at 70° C. for 2 hours, and the height or distance (mm) of an end of the test specimen lifted or raised from the adherend surface is measured and defined as the “split distance” (mm).

2. The double-coated pressure-sensitive adhesive sheet for fixing a flexible printed circuit board, according to claim 1, further comprising a non-silicone release liner or liners present on or above both surfaces of the pressure-sensitive adhesive unit.

3. The double-coated pressure-sensitive adhesive sheet for fixing a flexible printed circuit board, according to claim 1, wherein each of the first and second pressure-sensitive adhesive layers has a gel fraction of from 10% to 600.

4. The double-coated pressure-sensitive adhesive sheet for fixing a flexible printed circuit board, according to claim 1, wherein each of the first and second pressure-sensitive adhesive layers is formed from an acrylic pressure-sensitive adhesive including one or more acrylic polymers and one or more crosslinking agents and containing substantially no tackifier resin.

5. The double-coated pressure-sensitive adhesive sheet for fixing a flexible printed circuit board, according to claim 4, wherein the acrylic pressure-sensitive adhesive contains 0.15 to 1 part by weight of one or more isocyanate crosslinking agents and 0 to 0.05 part by weight of one or more epoxy crosslinking agents per 100 parts by weight of the acrylic polymers.

6. The double-coated pressure-sensitive adhesive sheet for fixing a flexible printed circuit board, according to claim 1, comprising a polyolefinic release liner or liners as non-silicone release liners present on or above both surfaces of the pressure-sensitive adhesive unit.

7. The double-coated pressure-sensitive adhesive sheet for fixing a flexible printed circuit board, according to claim 2, wherein each of the first and second pressure-sensitive adhesive layers has a gel fraction of from 10% to 60%.

8. The double-coated pressure-sensitive adhesive sheet for fixing a flexible printed circuit board, according to claim 2, wherein each of the first and second pressure-sensitive adhesive layers is formed from an acrylic pressure-sensitive adhesive including one or more acrylic polymers and one or more crosslinking agents and containing substantially no tackifier resin.

9. The double-coated pressure-sensitive adhesive sheet for fixing a flexible printed circuit board, according to claim 3, wherein each of the first and second pressure-sensitive adhesive layers is formed from an acrylic pressure-sensitive adhesive including one or more acrylic polymers and one or more crosslinking agents and containing substantially no tackifier resin.

10. The double-coated pressure-sensitive adhesive sheet for fixing a flexible printed circuit board, according to claim 7, wherein each of the first and second pressure-sensitive adhesive layers is formed from an acrylic pressure-sensitive adhesive including one or more acrylic polymers and one or more crosslinking agents and containing substantially no tackifier resin.

11. The double-coated pressure-sensitive adhesive sheet for fixing a flexible printed circuit board, according to claim 8, wherein the acrylic pressure-sensitive adhesive contains 0.15 to 1 part by weight of one or more isocyanate crosslinking agents and 0 to 0.05 part by weight of one or more epoxy crosslinking agents per 100 parts by weight of the acrylic polymers.

12. The double-coated pressure-sensitive adhesive sheet for fixing a flexible printed circuit board, according to claim 9, wherein the acrylic pressure-sensitive adhesive contains 0.15 to 1 part by weight of one or more isocyanate crosslinking agents and 0 to 0.05 part by weight of one or more epoxy crosslinking agents per 100 parts by weight of the acrylic polymers.

13. The double-coated pressure-sensitive adhesive sheet for fixing a flexible printed circuit board, according to claim 10, wherein the acrylic pressure-sensitive adhesive contains 0.15 to 1 part by weight of one or more isocyanate crosslinking agents and 0 to 0.05 part by weight of one or more epoxy crosslinking agents per 100 parts by weight of the acrylic polymers.

14. The double-coated pressure-sensitive adhesive sheet for fixing a flexible printed circuit board, according to claim 2, comprising a polyolefinic release liner or liners as non-silicone release liners present on or above both surfaces of the pressure-sensitive adhesive unit.

15. The double-coated pressure-sensitive adhesive sheet for fixing a flexible printed circuit board, according to claim 3, comprising a polyolefinic release liner or liners as non-silicone release liners present on or above both surfaces of the pressure-sensitive adhesive unit.

16. The double-coated pressure-sensitive adhesive sheet for fixing a flexible printed circuit board, according to claim 4, comprising a polyolefinic release liner or liners as non-silicone release liners present on or above both surfaces of the pressure-sensitive adhesive unit.

17. The double-coated pressure-sensitive adhesive sheet for fixing a flexible printed circuit board, according to claim 5, comprising a polyolefinic release liner or liners as non-silicone release liners present on or above both surfaces of the pressure-sensitive adhesive unit.

18. The double-coated pressure-sensitive adhesive sheet for fixing a flexible printed circuit board, according to claim 7, comprising a polyolefinic release liner or liners as non-silicone release liners present on or above both surfaces of the pressure-sensitive adhesive unit.

19. The double-coated pressure-sensitive adhesive sheet for fixing a flexible printed circuit board, according to claim 8, comprising a polyolefinic release liner or liners as non-silicone release liners present on or above both surfaces of the pressure-sensitive adhesive unit.

20. The double-coated pressure-sensitive adhesive sheet for fixing a flexible printed circuit board, according to claim 11, comprising a polyolefinic release liner or liners as non-silicone release liners present on or above both surfaces of the pressure-sensitive adhesive unit.
